(19) United States
(12) Patent Application Publication
(10) Pub. No.: US 2026/0168260 A1
(43) Pub. Date: Jun. 18, 2026

(54) HIGH TOUGHNESS LIGHTWEIGHT LAMINATED FLOORBOARD AND PREPARATION METHOD THEREOF

(71) Applicant: M.J. International Flooring and Interior Products Inc., Xinbei (TW)

(72) Inventor: Benyuan Chen, Xinbei (CN)

(21) Appl. No.: 19/536,379

(22) Filed: Feb. 11, 2026

(30) Foreign Application Priority Data
Jan. 14, 2026 (CN) 202610049082.1

(51) Int. Cl. E04F 15/04; B32B 27/08; B32B 27/28; E04F 15/10

(52) U.S. Cl. CPC E04F 15/04; B32B 27/08; B32B 27/285; E04F 15/102; E04F 15/107

(57) ABSTRACT

Provided are a high toughness lightweight laminated floorboard and its preparation method. The high toughness lightweight laminated floorboard includes a UV curing layer, a transparent wear-resistant layer, a color film layer, a substrate layer, and an anti-slip layer arranged from top to bottom. The substrate layer includes the following weight parts of raw materials: 50-70 parts of matrix resin, 7-15 parts of dispersant, 8-12 parts of elastomer, 5-9 parts of toughening agent, 35-45 parts of light calcium carbonate, 1-2 parts of glycerol monostearate, 0.8-1.2 parts of stabilizer, 7-9 parts of compatibilizer, and 2-4 parts of foaming agent. The substrate layer is prepared through matrix resin, dispersant, elastomer, toughening agent, lightweight calcium carbonate, compatibilizer, foaming agent, etc. The proportion of each component is precisely controlled, and the substrate layer has both lightweight, excellent impact, bending resistance, stable quality, and the preparation method is simple and suitable for industrial production.

### CROSS-REFERENCE TO RELATED APPLICATIONS

This application claims priority to Chinese Patent Application No. 202610049082.1, filed on Jan. 14, 2026, which is hereby incorporated by reference in its entirety.

### TECHNICAL FIELD

The present disclosure relates to the field of floorboards technologies, and in particular, to a high toughness lightweight laminated floorboard and a preparation method thereof.

### BACKGROUND

The current mainstream plastic floorboard mostly uses adhesive laying technology, which fixes the floorboard to an original ground through specialized adhesives. Although the operation process of this technology is relatively simple, it has obvious defects: firstly, the curing cycle of the adhesive is long, usually taking 24-48 hours to complete the curing, greatly extending the overall construction period and increasing construction and time costs; secondly, the irreversible bonding properties of adhesives require destructive peeling of the floorboard during subsequent demolition, rendering it impossible to recycle and reuse. This not only results in material waste but also increases the difficulty of demolition construction and the amount of construction waste.

At the same time, traditional plastic floorboards are mostly a monolithic homogeneous structure with a thickness of generally 2-5 mm or more. This type of thick structure has significant disadvantages in space limited scenarios: in high-rise residential buildings, basements, and renovation of old buildings that are sensitive to indoor net height, thick floorboard will directly compress the effective use space, reducing the comfort of living and use. At the same time, traditional plastic floorboards are generally hard and lack toughness to ensure basic rigidity. The internal stress distribution of the substrate is uneven, and it is prone to ineffective problems such as edge curling, cracking, and delamination under local stress during installation, trampling impact during daily use, or temperature changes, which limits its service life.

At present, plastic floorboard substrates are mostly based on polyvinyl chloride (PVC) and polypropylene (PP), combined with lightweight calcium carbonate (CaCO₃) as a filler to achieve cost control and lightweight requirements. However, there are many inherent problems in the mixing process of PVC or PP/CaCO₃ composite systems: the interface compatibility between PVC resin and PP resin with CaCO₃ particles is poor, CaCO₃ is prone to agglomeration, resulting in difficulties in material plasticization and prolonged plasticization time. Even if the mixing time is extended, it is difficult to achieve complete plasticization, which not only reduces production efficiency but also causes uneven dispersion of components inside the substrate. Incomplete plasticization and agglomeration of fillers can cause fluctuations in the mechanical properties of the substrate, further exacerbating the risk of warping and cracking of the floorboards during use.

Furthermore, traditional PVC or PP/CaCO₃ substrates often sacrifice toughness to improve rigidity or increase thickness to ensure toughness, rendering it difficult to balance dual requirements of high toughness and lightweight.

### SUMMARY

In order to overcome the shortcomings and deficiencies in the existing technology, the purpose of the present disclosure is to provide a high toughness lightweight laminated floorboard and a preparation method thereof. The produced high toughness lightweight laminated floorboard has stable quality, can meet the dual requirements of high toughness and lightweight, and has good thermal stability performance, thereby avoiding a warping problem of lightweight floorboard, and has superior comprehensive performance. At the same time, the preparation method of the high toughness lightweight laminated floorboard is simple in process, easy to control in operation, and convenient for industrial mass production.

The purpose of the present disclosure is achieved through the following technical solution: a high toughness lightweight laminated floorboard, including: a UV curing layer, a transparent wear-resistant layer, a color film layer, a substrate layer, and an anti-slip layer arranged in sequence from top to bottom.

In the present disclosure, the UV curing layer has stronger resistance to dirt and chemical corrosion, can resist the erosion of oil stains and cleaning agents, and improve the glossiness of the floor surface. The transparent wear-resistant layer can resist external scratching and wear, while ensuring that the color film layer pattern is clear and visible. At the same time, the color film layer can provide diverse appearance textures, such as wood texture, stone texture, etc., to meet decorative needs. The anti-slip layer can enhance the friction between the floor and the ground, prevent sliding after installation, and ensure safety during use. The substrate layer is a mechanical core layer of the laminated floorboard, which bears the functions of support, impact resistance, and bending resistance, while affecting the toughness and thinning of the laminated floorboard. It also has good compatibility with the color film layer and the anti-slip layer.

In an implementation mode, the substrate layer includes the following weight parts of raw materials: 50-70 parts of matrix resin, 7-15 parts of dispersant, 8-12 parts of elastomer, 5-9 parts of toughening agent, 35-45 parts of light calcium carbonate, 1-2 parts of glycerol monostearate, 0.8-1.2 parts of stabilizer, 7-9 parts of compatibilizer, and 2-4 parts of foaming agent.

The substrate layer of the present disclosure is prepared by the matrix resin, the dispersant, the elastomer, the toughening agent, the lightweight calcium carbonate, the compatibilizer, the foaming agent, etc. The composition and proportion of each component are precisely controlled, and each component is coordinated with each other to produce the substrate layer that has both lightweight, excellent impact and bending resistance effects, enabling the laminated floorboard to achieve both high toughness and lightweight. Specifically, the substrate matrix resin can provide basic rigidity, formability, and dimensional stability. The lightweight calcium carbonate can adjust the density of the substrate and achieve lightweight properties. The dispersant enhances an interfacial compatibility between polyvinyl chloride matrix and lightweight calcium carbonate particles by forming a more uniform coating on the surface of CaCO₃ particles, which helps to improve the dispersion of CaCO₃ in the melt, thereby enhancing the foaming performance of the matrix resin and the quality of the final product. They also have good thermal stability, thereby avoiding warping that may occur in lightweight floorboard after prolonged use. The elastomer and toughening agent can enhance the bending resistance, impact toughness, and tear strength of the substrate. As a bridge function, the compatibilizer not only enhances the interfacial compatibility between non-polar and polar components but also improves the mechanical properties of the substrate layer. Moreover, the polar functional groups of the compatibilizer can anchor on the surface of the substrate layer, thereby forming an active interface layer and enhancing the intermolecular forces with the color film layer and the anti-slip layer.

In an implementation mode, the high toughness lightweight laminated floorboard has a thickness of 1-2 mm. It is thinner than traditional plastic floorboard and can balance high toughness and lightweight. Where, the substrate layer has a thickness of 0.8-1.2 mm, the UV curing layer has a thickness of 0.03-0.07 mm, the transparent wear-resistant layer has a thickness of 0.1-0.3 mm, the color film layer has a thickness of 0.03-0.07 mm, and the anti-slip layer has a thickness of 0.1-0.3 mm.

In an implementation mode, the matrix resin includes at least one of polyvinyl chloride or polypropylene.

In an implementation mode, the toughening agent is chlorinated polyethylene (CPE), and the CPE is a polar elastomer with excellent compatibility with PVC and PP, and can improve the low-temperature brittleness of PVC and enhance the tear strength of the substrate.

In an implementation mode, the lightweight calcium carbonate has a particle size of 300-800 mesh. The present disclosure uses fine particle sized carbonic acid, combined with the dispersant, to more evenly coat the PVC matrix and reduce the occurrence of agglomeration.

In an implementation mode, the elastomer is polyolefin elastomer (POE), and the POE is a non-polar elastic material that can significantly enhance the bending and impact toughness of the substrate.

In an implementation mode, the compatibilizer is at least one of maleic anhydride grafted polyolefin elastomer, maleic anhydride grafted polypropylene, or ethylene-acrylate-maleic anhydride ternary copolymer, which enhances the interfacial compatibility between non-polar components POE and PP and polar components PVC and CPE, reduces phase separation, and ensures the synergistic effect of each component.

In an implementation mode, the stabilizer is dibutyltin dilaurate, which inhibits the dehydrochlorination reaction of PVC during high-temperature mixing, thereby avoiding material yellowing and mechanical property degradation.

In an implementation mode, the foaming agent includes at least one of AC foaming agent, yellow foaming agent, and white foaming agent.

In an implementation mode, the foaming agent is a mixture of yellow foaming agent and white foaming agent in a weight ratio of 1:0.8-1.2.

In an implementation mode, the dispersant includes the following weight parts of raw materials: 100-150 parts of methyl methacrylate, 12-15 parts of butyl acrylate, 6-8 parts of acrylic terminated organic silicon monomer, 5-6 parts of glycidyl methacrylate, 0.4-0.6 parts of emulsifier, and 0.6-0.8 parts of potassium persulfate.

The present disclosure produces a high viscosity polymer dispersant by using the methyl methacrylate, the butyl acrylate, the acrylic ester terminated organic silicon monomer, and the glycidyl methacrylate. Where, the glycidyl methacrylate in the dispersant contains epoxy groups that can react chemically with hydroxyl groups on the surface of CaCO₃, allowing the dispersant to firmly adsorb on the surface of CaCO₃ and form a uniform coating layer. At the same time, under high-temperature conditions of hot-pressing composite of the color film layer, substrate layer, and anti-slip layer, the epoxy groups of glycidyl methacrylate can react chemically with polar groups such as hydroxyl and carboxyl groups in the color film layer and anti-slip layer, thus forming chemical bonds and improving interlayer peel strength. The low surface energy characteristics of organosilicon side chains can reduce the agglomeration force between CaCO₃ and lower the interfacial tension on the surface of the substrate layer, rendering it easier for the color film layer and anti-slip layer to wet the substrate surface during hot-pressing, reducing interlayer bubble residue. The formed acrylic ester main chain has good compatibility with PVC matrix, PP matrix, and POE elastomer. It is worth mentioning that the high viscosity polymer dispersant produced enhances the interfacial compatibility between PVC or PP matrix and CaCO₃ particles by forming a more uniform coating layer on the surface of CaCO₃ particles, avoiding agglomeration between CaCO₃ particles. At the same time, the high viscosity dispersant can effectively improve the adhesion between the two phases, making them evenly dispersed in the PVC matrix, avoiding the problem of inorganic fillers interfering with the decomposition of the foaming agent or gas release, thereby improving the lightweighting of the substrate layer. When the amount of dispersant added is too high, it will cause the system viscosity to be too high, increase the resistance to bubble growth, thereby hindering a further expansion of bubbles, and leading to an increase in the density of the laminated floor, which cannot achieve the goal of lightweighting.

In an implementation mode, the emulsifier is lauryl sodium sulfate.

In an implementation mode, the dispersant is prepared by the following steps:
A1: mixing methyl methacrylate, butyl acrylate, acrylic terminated organic silicon monomer, and glycidyl methacrylate to obtain a reaction mixture;
A2: dissolving potassium persulfate in deionized water, then adding emulsifier to a reaction vessel and stirring evenly, placing in a constant temperature water bath at 55-65° C., then adding the reaction mixture and stirring at a speed of 200-250 r/min for 5-7 hours, when a conversion rate of the methyl methacrylate reaches 97-99%, a material is taken for demulsification, drying, and obtaining the dispersant.

The present disclosure further provides a method for preparing the high toughness lightweight laminated floorboard, including the following steps:
S1: mixing the matrix resin, dispersant, elastomer, toughening agent, light calcium carbonate, monoglyceride monostearate, stabilizer, compatibilizer, and foaming agent evenly and adding them to a blender mill, raising temperature to 160-200° C. and mixing for 5-10 minutes, after mixing evenly, releasing tablets;
S2: placing mixed mixture in a flat vulcanizing machine for vulcanization, with a vulcanization temperature of 160-200° C., a pressure of 8-12 MPa, and a vulcanization time of 8-12 minutes to obtain the substrate layer;
S3: placing the transparent wear-resistant layer and color film layer in sequence on an upper end face of the substrate layer, and placing the anti-slip layer at a lower end of the substrate layer, after bonding through a hot-pressing process, cooling down to 35-55° C. and maintaining a pressure of 5-10 Mpa for 25-35 minutes to obtain a semi-finished product;
S4: performing a surface coating and UV curing process to an upper end face of the semi-finished product to obtain the UV curing layer, and obtaining the high toughness and lightweight laminated floorboard.

In an implementation mode, step S4 is followed by step S5, which includes the following steps: stamping the high toughness lightweight laminated floorboard obtained in step S4 with a knife die to produce products of corresponding size specifications, and then processing one side of the high toughness lightweight laminated floorboard into an L-shaped splicing groove and the other side into an inverted L-shaped splicing groove through a locking machine. During the process of laying the laminated floorboard, adjacent two pieces of high toughness lightweight laminated floorboard can be securely connected through L-shaped splicing groove and the inverted L-shaped splicing groove by buckle connections, achieving stable connection between adjacent two pieces of high toughness lightweight laminated floorboards. Specifically, an opening of the L-shaped splicing groove is arranged upward, and an opening of the inverted L-shaped splicing groove is arranged downward.

In an implementation mode, the color film layer is selected as an ink printing film with good compatibility with the matrix resin. In an implementation mode, the transparent wear-resistant layer, color film layer, and anti-slip layer are all made of PVC or PP materials.

In an implementation mode, in step S2, a hot-pressing temperature is 130-170° C., a pressure is 5-10 Mpa, and a hot-pressing time is 25-35 min during the hot-pressing process.

In an implementation mode, in step S4, polyurethane acrylic resin is selected as a UV coating material.

In the present disclosure, the preparation method of the high toughness lightweight laminated floorboard is simple in process, easy to control in operation, and convenient for industrial mass production.

The beneficial effects of the present disclosure are as follows.

1. The high toughness lightweight laminated floorboard of the present disclosure includes the UV curing layer, the transparent wear-resistant layer, the color film layer, the substrate layer, and the anti-slip layer arranged in sequence from top to bottom. The UV curing layer has stronger resistance to dirt and chemical corrosion, can resist the erosion of oil stains and cleaning agents, and improve the glossiness of the floor surface. The transparent wear-resistant layer can resist external scratching and wear, while ensuring that the color film layer pattern is clear and visible. At the same time, the color film layer can provide diverse appearance textures, such as wood texture, stone texture, etc., to meet decorative needs. The anti-slip layer can enhance the friction between the floor and the ground, prevent sliding after installation, and ensure safety during use.

2. The substrate layer of the present disclosure is prepared by the matrix resin, the dispersant, the elastomer, the toughening agent, the lightweight calcium carbonate, the compatibilizer, the foaming agent, etc. The composition and proportion of each component are precisely controlled, and each component is coordinated with each other to produce the substrate layer that has both lightweight and excellent impact and bending resistance effects, enabling the laminated floorboard to achieve both high toughness and lightweight.

3. The high viscosity polymer dispersant prepared in the present disclosure enhances the interfacial compatibility between the matrix resin and CaCO₃ particles by forming a more uniform coating layer on the surface of CaCO₃ particles, thus avoiding agglomeration between CaCO₃ particles. At the same time, the high viscosity dispersant can effectively improve the adhesion between the two phases, allowing them to be uniformly dispersed in the matrix resin, avoiding the problem of inorganic fillers interfering with the decomposition of the foaming agent or gas release, thereby improving the lightweighting of the substrate layer.

### BRIEF DESCRIPTION OF DRAWINGS

FIG. 1 shows a diagram of a product of the present disclosure.

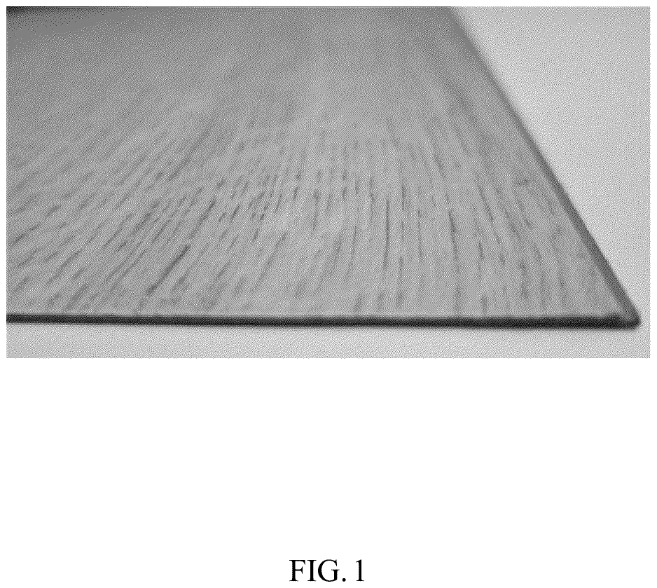

### DESCRIPTION OF EXAMPLES

In order to facilitate the understanding of those skilled in the art, the present disclosure will be further explained in combinations with the examples below. The content mentioned in the examples is not a limitation of the present disclosure.

### Example 1

In this example, a high toughness lightweight laminated floorboard includes a UV curing layer, a transparent wear-resistant layer, a color film layer, a substrate layer, and an anti-slip layer arranged in sequence from top to bottom.

Furthermore, the substrate layer includes the following weight parts of raw materials: 50 parts of matrix resin, 7 parts of dispersant, 8 parts of elastomer, 5 parts of toughening agent, 35 parts of light calcium carbonate, 1 part of glycerol monostearate, 0.8 parts of stabilizer, 7 parts of compatibilizer, and 2 parts of foaming agent.

In this example, the matrix resin is polyvinyl chloride, and the polyvinyl chloride is selected from the SG-7 model of Xinjiang Tianye.

Furthermore, the high toughness lightweight laminated floorboard has a thickness of 1.5 mm, the substrate layer has a thickness of 1 mm, the UV curing layer has a thickness of 0.05 mm, the transparent wear-resistant layer has a thickness of 0.2 mm, the color film layer has a thickness of 0.05 mm, and the anti-slip layer has a thickness of 0.2 mm.

Furthermore, the toughening agent is chlorinated polyethylene. The chlorinated polyethylene is selected from CPE135A.

Furthermore, the elastomer is a polyolefin elastomer. The polyolefin elastomer is selected from Dow Chemical ENGAGE™ 840.

Furthermore, the compatibilizer is maleic anhydride grafted polyolefin elastomer, and the maleic anhydride grafted polyolefin elastomer is selected from TAFMER™ MD715 by Mitsui Chemicals.

Furthermore, the stabilizer is dibutyltin dilaurate.

Furthermore, the lightweight calcium carbonate has a particle size of 500 mesh.

Furthermore, the foaming agent is a mixture of yellow foaming agent and white foaming agent in a weight ratio of 1:1.

Furthermore, the dispersant includes the following weight parts of raw materials: 120 parts of methyl methacrylate, 14 parts of butyl acrylate, 7 parts of acrylic terminated organic silicon monomer, 6 parts of glycidyl methacrylate, 0.5 parts of emulsifier, and 0.7 parts of potassium persulfate.

In this example, the acrylic terminated organic silicon monomer has a relative molecular weight of 6000, selected from Guangzhou Sloco Polymer Co., Ltd., with a model of 3821F42.

Furthermore, the emulsifier is lauryl sodium sulfate.

Furthermore, the dispersant is prepared by the following steps:
A1: mixing methyl methacrylate, butyl acrylate, acrylic terminated organic silicon monomer, and glycidyl methacrylate to obtain a reaction mixture;
A2: dissolving potassium persulfate in deionized water, then adding emulsifier to a reaction vessel and stirring evenly, placing in a constant temperature water bath at 60° C., then adding the reaction mixture and stirring at a speed of 230 r/min for 6 hours, when a conversion rate of the methyl methacrylate reaches 98%, a material is taken for demulsification, drying, and obtaining the dispersant.

This example further provides a method for preparing the high toughness lightweight laminated floorboard, including the following steps:
S1: mixing the matrix resin, dispersant, elastomer, toughening agent, light calcium carbonate, monoglyceride monostearate, stabilizer, compatibilizer, and foaming agent evenly and adding them to a blender mill, raising temperature to 180° C. and mixing for 8 minutes, after mixing evenly, releasing tablets;
S2: placing mixed mixture in a flat vulcanizing machine for vulcanization, with a vulcanization temperature of 180° C., a pressure of 10 MPa, and a vulcanization time of 10 minutes to obtain the substrate layer;
S3: placing the transparent wear-resistant layer and color film layer in sequence on an upper end face of the substrate layer, and placing the anti-slip layer at a lower end of the substrate layer, after bonding through a hot-pressing process, cooling down to 40° C. and maintaining a pressure of 8 Mpa for 30 minutes to obtain a semi-finished product;
S4: performing a surface coating and UV curing process to an upper end face of the semi-finished product to obtain the UV curing layer, and obtaining the high toughness and lightweight laminated floorboard.

Furthermore, the transparent wear-resistant layer, the color film layer, and the anti-slip layer are all made of PVC materials.

Furthermore, in step S2, in the hot-pressing process, a hot-pressing temperature is 150° C., a pressure is 8 Mpa, and a hot-pressing time is 30 min.

Furthermore, in step S4, a UV coating material is selected from existing polyurethane acrylic resin.

### Example 2

In this example, the substrate layer includes the following weight parts of raw materials: 60 parts of matrix resin, 11 parts of dispersant, 10 parts of elastomer, 7 parts of toughening agent, 40 parts of light calcium carbonate, 1.5 parts of glycerol monostearate, 1 part of stabilizer, 8 parts of compatibilizer, and 3 parts of foaming agent.

In this example, the compatibilizer is ethylene-acrylate-maleic anhydride ternary copolymer that is selected from Akoma Lotader® 5500.

This example further provides a method for preparing the high toughness lightweight laminated floorboard, including the following steps:
S1: mixing the matrix resin, dispersant, elastomer, toughening agent, light calcium carbonate, monoglyceride monostearate, stabilizer, compatibilizer, and foaming agent evenly and adding them to a blender mill, raising temperature to 180° C. and mixing for 8 minutes, after mixing evenly, releasing tablets;
S2: placing mixed mixture in a flat vulcanizing machine for vulcanization, with a vulcanization temperature of 180° C., a pressure of 10 MPa, and a vulcanization time of 10 minutes to obtain the substrate layer;
S3: placing the transparent wear-resistant layer and color film layer in sequence on an upper end face of the substrate layer, and placing the anti-slip layer at a lower end of the substrate layer, after bonding through a hot-pressing process, cooling down to 40° C. and maintaining a pressure of 8 Mpa for 30 minutes to obtain a semi-finished product;
S4: performing a surface coating and UV curing process to an upper end face of the semi-finished product to obtain the UV curing layer, and obtaining the high toughness and lightweight laminated floorboard.

The remaining content of this example is the same as that of example 1.

### Example 3

In this example, the substrate layer includes the following weight parts of raw materials: 70 parts of matrix resin, 15 parts of dispersant, 12 parts of elastomer, 9 parts of toughening agent, 45 parts of light calcium carbonate, 2 parts of glycerol monostearate, 1.2 parts of stabilizer, 9 parts of compatibilizer, and 4 parts of foaming agent.

In this example, the matrix resin is polypropylene, and the polypropylene is selected from Yanshan Petrochemical K7100.

Furthermore, the compatibilizer is maleic anhydride grafted polypropylene, and the maleic anhydride grafted polypropylene is selected from ExxonMobil PO 1015.

This example further provides a method for preparing the high toughness lightweight laminated floorboard, including the following steps:
S1: mixing the matrix resin, dispersant, elastomer, toughening agent, light calcium carbonate, monoglyceride monostearate, stabilizer, compatibilizer, and foaming agent evenly and adding them to a blender mill, raising temperature to 180° C. and mixing for 8 minutes, after mixing evenly, releasing tablets;
S2: placing mixed mixture in a flat vulcanizing machine for vulcanization, with a vulcanization temperature of 180° C., a pressure of 10 MPa, and a vulcanization time of 10 minutes to obtain the substrate layer;
S3: placing the transparent wear-resistant layer and color film layer in sequence on an upper end face of the substrate layer, and placing the anti-slip layer at a lower end of the substrate layer, after bonding through a hot-pressing process, cooling down to 40° C. and maintaining a pressure of 8 Mpa for 30 minutes to obtain a semi-finished product;
S4: performing a surface coating and UV curing process to an upper end face of the semi-finished product to obtain the UV curing layer, and obtaining the high toughness and lightweight laminated floorboard.

Furthermore, the transparent wear-resistant layer, color film layer, and anti-slip layer are all made of PP materials.

The remaining content of this example is the same as that of example 1.

### Example 4

This example provides a method for preparing the high toughness lightweight laminated floorboard, including the following steps:

S1: mixing the matrix resin, dispersant, elastomer, toughening agent, light calcium carbonate, monoglyceride monostearate, stabilizer, compatibilizer, and foaming agent evenly and adding them to a blender mill, raising temperature to 180° C. and mixing for 8 minutes, after mixing evenly, releasing tablets;

S2: placing mixed mixture in a flat vulcanizing machine for vulcanization, with a vulcanization temperature of 180° C., a pressure of 10 MPa, and a vulcanization time of 10 minutes to obtain the substrate layer;

S3: placing the transparent wear-resistant layer and color film layer in sequence on an upper end face of the substrate layer, and placing the anti-slip layer at a lower end of the substrate layer, after bonding through a hot-pressing process, cooling down to 40° C. and maintaining a pressure of 8 Mpa for 30 minutes to obtain a semi-finished product;

S4: performing a surface coating and UV curing process to an upper end face of the semi-finished product to obtain the UV curing layer, and obtaining the high toughness and lightweight laminated floorboard;

S5: stamping the high toughness lightweight laminated floorboard obtained in step S4 with a knife die to produce products of corresponding size specifications, and then processing one side of the high toughness lightweight laminated floorboard into an L-shaped splicing groove and the other side into an inverted L-shaped splicing groove through a locking machine.

The remaining content of this example is the same as that of example 1.

### Comparative Example 1

The difference between this comparative example and Example 1 is that an equal amount of methyl methacrylate is used instead of the acrylic terminated organic silicon monomer.

The remaining content of this example is the same as that of example 2.

### Comparative Example 2

The difference between this comparative example and Example 2 is that an equal amount of polyvinyl chloride is used instead of the dispersant.

The remaining content of this example is the same as that of example 2.

### Comparative Example 3

The difference between this comparative example and Example 2 is that the substrate layer includes the following weight parts of raw materials: 60 parts of polyvinyl chloride, 20 parts of dispersant, 10 parts of elastomer, 7 parts of toughening agent, 40 parts of light calcium carbonate, 1.5 parts of glycerol monostearate, 1 part of stabilizer, 8 parts of compatibilizer, and 3 parts of foaming agent.

The remaining content of this example is the same as that of example 2.

### Performance Testing Experiment

Firstly, performance tests were conducted on the high toughness lightweight laminated floorboard produced in Examples 1-3 and Comparative Examples 1-3, including density, tensile properties, impact resistance, bending properties, elastic modulus, and dimensional stability, as shown in Table 1 below:

TABLE 1

| | | | | | Comparative | Comparative | Comparative |
|---|---|---|---|---|---|---|---|
| Items | | Example 1 | Example 2 | Example 3 | Example 1 | Example 2 | Example 3 |
| Density (g/cm3) | | 1.68 | 1.71 | 1.85 | 1.76 | 1.87 | 2.89 |
| Tensile strength | | 32.8 | 38.4 | 41.2 | 28.3 | 30.2 | 41.8 |
| (Mpa) | | | | | | | |
| Impact resistance | | Falling | Falling | Falling | Falling from | Falling from | Falling from |
| | | from a | from a | from a | a height of | a height of | a height of |
| | | height of | height of | height of | 1600 mm | 1580 mm | 1920 mm |
| | | 1680 mm | 1800 mm | 2100 mm | without | without | without |
| | | without | without | without | cracks or | cracks or | cracks or |
| | | cracks or | cracks or | cracks or | obvious | obvious | obvious |
| | | obvious | obvious | obvious | depression | depression | depression |
| | | depressions | depressions | depressions | | | |
| Elasticity modulus | | 509.63 | 537.21 | 584.78 | 480.65 | 495.36 | 615.95 |
| (Mpa) | | | | | | | |
| Bending | Bending | 31 | 37 | 41 | 27 | 28 | 39 |
| performance | strength | | | | | | |
| | (N) | | | | | | |
| | Fracture | 0.8 | 1.0 | 1.1 | 0.6 | 0.6 | 1.1 |
| | deformation | | | | | | |
| | amount | | | | | | |
| | (cm) | | | | | | |
| Dimensional | Vertical | 0.12 | 0.07 | 0.06 | 0.20 | 0.09 | 0.06 |
| stability | dimension | | | | | | |
| | reduction | | | | | | |
| | ratio (%) | | | | | | |
| | Horizontal | 0.10 | 0.08 | 0.06 | 0.19 | 0.10 | 0.07 |
| | dimension | | | | | | |
| | reduction | | | | | | |
| | ratio (%) | | | | | | |

Tensile strength test: WDT-W electronic universal material testing machine is used, referring to GB/T 1040.1-2025, with a tensile rate of 100 mm/min.

Impact resistance test: according to QB/T 2864-2007 “Plastic Floorboard”, placing 500 g balls at a certain height and dropping them to test whether there are no cracks or obvious depressions.

Bending performance test: according to GB/T 9341-2008 “Determination of Plastic Bending Performance”, testing its bending force and deformation at fracture.

Elastic modulus test: according to GB/T 9341-2008 “Determination of Plastic Bending Performance”.

Dimensional stability test: placing the high toughness lightweight laminated floorboard in an oven at 80° C. for 6 hours, then taking it out and leaving it at room temperature for 24 hours. Measuring the size changes before and after baking.

The above examples are the preferred implementation schemes for the present disclosure. Besides that, the present disclosure can also be implemented in other ways, and any obvious substitution is within the protection scope of the present disclosure without departing from the inventive concept.

What is claimed is:

1. A high toughness lightweight laminated floorboard, comprising: a UV curing layer, a transparent wear-resistant layer, a color film layer, a substrate layer, and an anti-slip layer arranged in sequence from top to bottom;
wherein the substrate layer comprises the following weight parts of raw materials: 50-70 parts of matrix resin, 7-15 parts of dispersant, 8-12 parts of elastomer, 5-9 parts of toughening agent, 35-45 parts of light calcium carbonate, 1-2 parts of glycerol monostearate, 0.8-1.2 parts of stabilizer, 7-9 parts of compatibilizer, and 2-4 parts of foaming agent.

2. The high toughness lightweight laminated floorboard according to claim 1, wherein the matrix resin comprises at least one of polyvinyl chloride or polypropylene.

3. The high toughness lightweight laminated floorboard according to claim 1, wherein the high toughness lightweight laminated floorboard has a thickness of 1-2 mm.

4. The high toughness lightweight laminated floorboard according to claim 1, wherein the dispersant comprises the following weight parts of raw materials: 100-150 parts of methyl methacrylate, 12-15 parts of butyl acrylate, 6-8 parts of acrylic terminated organic silicon monomer, 5-6 parts of glycidyl methacrylate, 0.4-0.6 parts of emulsifier, and 0.6-0.8 parts of potassium persulfate.

5. The high toughness lightweight laminated floorboard according to claim 1, wherein the toughening agent is CPE; the elastomer is POE; the compatibilizer is at least one of maleic anhydride grafted polyolefin elastomer, maleic anhydride grafted polypropylene, or ethylene-acrylate-maleic anhydride ternary copolymer.

6. The high toughness lightweight laminated floorboard according to claim 1, wherein the dispersant is prepared by the following steps:
A1: mixing methyl methacrylate, butyl acrylate, acrylic terminated organic silicon monomer, and glycidyl methacrylate to obtain a reaction mixture;
A2: dissolving potassium persulfate in deionized water, then adding emulsifier to a reaction vessel and stirring evenly, placing in a constant temperature water bath at 55-65° C., then adding the reaction mixture and stirring at a speed of 200-250 r/min for 5-7 hours, when a conversion rate of the methyl methacrylate reaches 97-99%, a material is taken for demulsification, drying, and obtaining the dispersant.

7. The high toughness lightweight laminated floorboard according to claim 1, wherein the foaming agent comprises at least one of AC foaming agent, yellow foaming agent, and white foaming agent.

8. A method for preparing the high toughness lightweight laminated floorboard according to claim 1, wherein it comprises the following steps:
S1: mixing the matrix resin, dispersant, elastomer, toughening agent, light calcium carbonate, monoglyceride monostearate, stabilizer, compatibilizer, and foaming agent evenly and adding them to a blender mill, raising temperature to 160-200° C. and mixing for 5-10 minutes, after mixing evenly, releasing tablets;
S2: placing mixed mixture in a flat vulcanizing machine for vulcanization, with a vulcanization temperature of 160-200° C., a pressure of 8-12 MPa, and a vulcanization time of 8-12 minutes to obtain the substrate layer;
S3: placing the transparent wear-resistant layer and color film layer in sequence on an upper end face of the substrate layer, and placing the anti-slip layer at a lower end of the substrate layer, after bonding through a hot-pressing process, cooling down to 35-55° C. and maintaining a pressure of 5-10 Mpa for 25-35 minutes to obtain a semi-finished product;
S4: performing a surface coating and UV curing process to an upper end face of the semi-finished product to obtain the UV curing layer, and obtaining the high toughness and lightweight laminated floorboard.

9. The method for preparing the high toughness lightweight laminated floorboard according to claim 8, it further comprises step S5, which comprises the following steps: stamping the high toughness lightweight laminated floorboard obtained in step S4 with a knife die to produce products of corresponding size specifications, and then processing one side of the high toughness lightweight laminated floorboard into an L-shaped splicing groove and the other side into an inverted L-shaped splicing groove through a locking machine.

10. The method for preparing the high toughness lightweight laminated floorboard according to claim 8, wherein in step S2, a hot-pressing temperature is 130-170° C., a pressure is 5-10 Mpa, and a hot-pressing time is 25-35 min during the hot-pressing process.
